(19) United States
(12) Patent Application Publication
(10) Pub. No.: US 2026/0245984 A1
(43) Pub. Date: Aug. 20, 2026

(54) COATINGS WITH POLYTETRAFLUOROETHYLENE PARTICLES FOR BATTERY SEPARATORS AND COATED BATTERY SEPARATORS WITH SAME

(71) Applicant: Celgard, LLC, Charlotte, NC (US)

(72) Inventors: Wenbin Yin, Charlotte, NC (US); Zhengming Zhang, Rock Hill, SC (US)

(21) Appl. No.: 18/876,673

(22) PCT Filed: Jun. 29, 2023
(86) PCT No.: PCT/US2023/026616

§ 371 Date: Dec. 19, 2024

Related U.S. Application Data
(60) Provisional application No. 63/357,014, filed on Jun. 30, 2022.

(51) Int. Cl. H01M 10/42; H01M 10/0525; H01M 50/417; H01M 50/42; H01M 50/426; H01M 50/434; H01M 50/443; H01M 50/449; H01M 50/489

(52) U.S. Cl. CPC H01M 10/4235; H01M 10/0525; H01M 50/417; H01M 50/42; H01M 50/426; H01M 50/434; H01M 50/443; H01M 50/449; H01M 50/489

(57) ABSTRACT

Described herein is a coated battery separator where the coating is provided on one or both sides of the battery separator. The coating comprises polytetrafluoroethylene (PTFE) particles and the coating is an outermost coating layer. In some cases, the coating may also comprise ceramic particles.

### CROSS-REFERENCE TO RELATED APPLICATIONS

This application is a 371 U.S. Application which claims priority to PCT Application No. PCT/US2023/026616, filed on Jun. 29, 2023, which claims the benefit of and priority to U.S. Provisional Application No. 63/357,014 filed Jun. 30, 2022 and hereby incorporated by reference herein.

### FIELD

This application pertains to coatings that contain polytetrafluoroethylene (PTFE) particles for battery separators and such coated separators. Particularly, this application pertains to outermost coatings that contain PTFE particles. These coatings and coated separators may be used in secondary batteries including lithium ion batteries.

### BACKGROUND

Celgard's seminal U.S. Pat. No. 6,432,586 (now RE 47 520) describes a ceramic coating for battery separators, including battery separators used in lithium-ion batteries. Ceramic coatings became the industry standard, and greatly improved the safety of lithium ion batteries.

One issue with certain ceramic-coated separators is that they can easily wear or damage equipment used by battery makers. Additionally, certain ceramic coatings commonly exhibit high moisture content, e.g., about 600 to 700 ppm. Thus, there is a need to address these issues.

High-temperature resistant polymers, like PTFE, have been used to coat battery separators and provide thermal stability. Organic solvent-based coatings of PTFE resulted in JIS Gurley to increase at least 1000s higher than the JIS Gurley of the uncoated separator, and often these organic solvent based coatings resulted in infinite Gurley measurements even when coatings having a thickness of 4 microns or less are used. Typically, high Gurley measurements mean that electrolyte flow across the separator is blocked or severely restricted. A need exists for a coating that provides thermal stability, but does not produce such a large Gurley increase.

Further still, particulate fluoropolymer coatings have been used in coatings for battery separators, e.g., polyvinylidene fluoride (PVDF) containing coatings, but these fluoropolymers are known to make the surface “sticky” and promoted adhesion of the separator with the electrode surface. A need exists for a coating that provides thermal stability, but does not make the surface “sticky” and does not promote adhesion of the separator with the electrode surface. Also, a need exists for a non-sticky coating that provides a low coefficient of friction.

### SUMMARY

In at least one aspect, object or embodiment, a coating and coated battery separator is described herein that solves or addresses one or more of the aforementioned issues or needs. For example, the present coating of the coated separator exhibits low friction, and consequently, possible damage to battery manufacturing equipment sometimes observed with the use of ceramic coatings is reduced. The coating also may have lower moisture content, e.g., 300 to 400 ppm. Additionally, coating materials may have a melting temp above 300 degrees Celsius, which may help absorb heat generated in the battery during use. This heat absorption will improve safety, by avoiding or delaying thermal runaway. The inventive coated battery separator comprises: 1) a battery separator, and 2) an outermost coating on at least one side of the battery separator. The outermost coating comprises PTFE particles in an amount of 10% to 100% by weight of particles. For example, the PTFE particles are 10% by weight of all the particles (90% by weight is other type particles). The outermost coating comprising PTFE particles may be added, for example, at about 1 to 20 grams per square meter (gsm) of separator, at 1 to 15 gsm, or possibly preferably at 1 to 10 gsm. In some embodiments, the outermost coating may further comprise ceramic particles, including, but not limited to, one or more selected from SiO₂, Al₂O₃, CaCO₃, TiO₂, SiS₂, SiPO₄, boehmite or y-AlO(OH), and AlO(OH). Coatings may further comprise a binder, including an acrylic binder. The battery separator may be a polyolefin battery separator and/or it may be a shutdown separator. In at least one possibly preferred aspect, object or embodiment, an aqueous based coating that contains polytetrafluoroethylene (PTFE) particles and a coated battery separator having same is described herein.

In some embodiments, the outermost coating may have a coefficient of friction (COF) is less than 0.4, less than 0.35, less than 0.3, less than 0.25.

In some embodiments, the outermost coating may have a melting point above 300° C. or about 320° C.

In some embodiments, the outermost coating has a moisture content of 300 ppm to 400 ppm or less.

In some embodiments, the JIS Gurley(s) of the coated separator is about 1 s to about 300 s or less, or less than 50 s higher, than that of the battery separator itself, i.e., without the coating or any coating, when the added coating is from 0.1 to 4 microns thick. Thicker coatings will typically result in higher Gurley increases. This added Gurley is “add-on” Gurley.

In one aspect, a lithium ion battery comprising the coated separator described herein above is formed. In some embodiments, the inventive coating is the outermost coating and may face a cathode of the lithium ion battery.

The coating method is not limited and may include known coating methods such as spray, print, dip, roll, knife, extrude, or the like. The coating slurry may be cured or dried by known methods at ambient temperature or in an oven depending on the slurry type.

In another aspect, object, or embodiment, a inventive coated polyolefin membrane is described (such as a coated dry process or dry stretch process polyolefin membrane). The coated polyolefin membrane may comprise: a polyolefin membrane; and a coating or coating layer on at least one side of the polyolefin membrane, wherein the coating comprises polytetrafluoroethylene (PTFE) particles and wherein the coating is an outermost coating or coating layer and may preferably face a cathode of a secondary lithium ion battery or cell.

### DESCRIPTION OF DRAWINGS

FIG. 1 is a coated battery separator according to some embodiments described herein.

FIG. 2 is a coated battery separator according to certain embodiments described herein.

FIG. 3 is a graph showing coefficient of friction (COF) of some coatings of the coated separators described herein.

FIG. 4 is a table including data, including add-on Gurley, according to some embodiments described herein.

### DESCRIPTION

The coated battery separator of at least certain preferred embodiments herein comprises: 1) a battery separator and 2) an outermost coating that comprises PTFE particles in an amount of 10% to 100% by weight of particles.

### Battery Separator

The battery separator is not so limited, and any membrane or film that is capable of being used as a battery separator, i.e., is both electrically insulating and ionically conductive, may be used.

The battery separator may have a thickness from 5 microns to 25 microns, from 5 to 20 microns, from 5 to 15 microns, or from 5 to 10 microns.

In some preferred embodiments, the battery separator may be microporous, nanoporous, or mesoporous. In some preferred embodiments, the battery separator may have an average pore size in a range from 0.01 to 1.0 microns.

The battery separator may be made of any acceptable thermoplastic material. In some preferred embodiments, the battery separator may be made of a polyolefin. The polyolefin may be a blend, homopolymer, copolymer, or terpolymer of polyethylene or polypropylene.

The battery separator may be formed by a wet process that utilizes solvents, oils, and/or plasticizers or a dry process that does not utilize solvents, oils, and/or plasticizers. A dry process may use particulate pore formers (e.g., a beta-nucleated biaxial stretching process) or may not (e.g., the Celgard® dry-stretch process).

The battery separator may be a monolayer, bi-layer, tri-layer, or multi-layer separator. In some embodiments, the battery separator may be a shutdown separator having a structure PP/PE, PP/PE/PP, PP/PE/PE/PP, or PP/PE/PP/PP, where PP is a polypropylene-containing layer and PE is a polyethylene-containing layer.

### Outermost Coating Layer

As understood, an outermost layer has no layers on top of it. The outermost layer may be provided directly onto the battery separator surface or the outermost layer may be formed on top of one, two, three, or more other layers. For example, in some embodiments, the outermost layer may be formed on top of a ceramic coating layer. The outermost layer may be a continuous or discontinuous (e.g., patterned) layer.

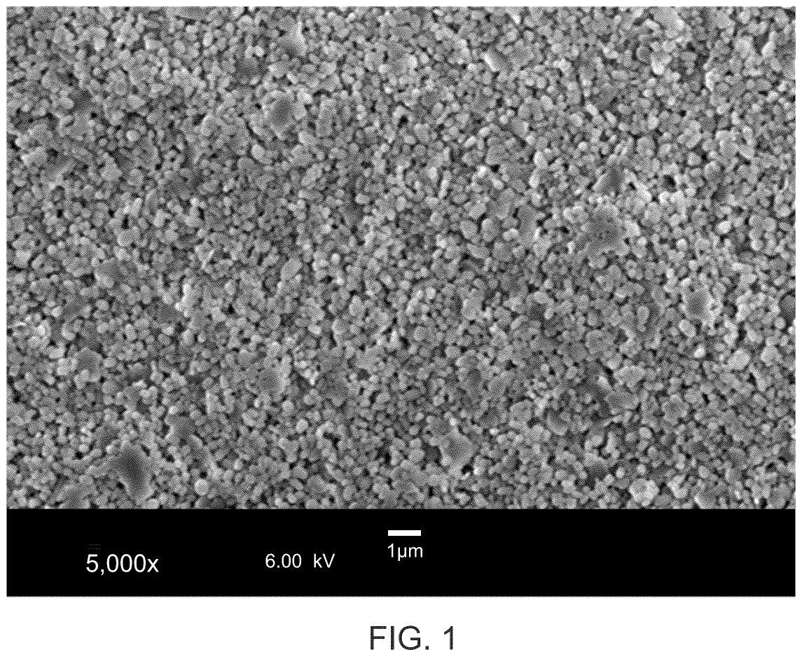

The outermost layer described herein may comprise PTFE particles in an amount of 10% to 100%, 15% to 100%, 20% to 100%, 25% to 100%, 30% to 100%, 35% to 100%, 40% to 100%, 45% to 100%, 50% to 100%, 55% to 100%, 60% to 100%, 65% to 100%, 70% to 100%, 75% to 100%, 80% to 100%, 85% to 100%, 90% to 100%, or 95% to 100% by weight of particles. PTFE particles exist if an aqueous coating slurry is used to form the outermost layer. If a solvent-based coating slurry is used, PTFE will dissolve, and the coating will not contain PTFE particles. SEM images of the coating are shown in FIG. 1, and the PTFE particles are visible. The outermost coating comprising PTFE particles may be added, for example, at about 1 to 20 grams per square meter (gsm) of separator, at 1 to 15 gsm, or possibly preferably at 1 to 10 gsm.

In some embodiments, the outermost coating layer may further comprise ceramic particles in addition to the PTFE particles. The ceramic particles are not so limited, but may be one or more selected from SiO₂, Al₂O₃, CaCO₃, TiO₂, SiS₂, SiPO₄, boehmite or y-AlO(OH), and AlO(OH).

In embodiments where a ceramic is added, the ratio of PTFE particles to ceramic particles may be in the range of from 1:100 to 100:1, from 1:75 to 75:1, from 1:50 to 50:1, from 1:25 to 25:1, from 1:10 to 10:1, from 1:9 to 9:1, from 1:8 to 8:1, from 1:7 to 7:1, from 1:6 to 6:1, from 1:5 to 5:1, from 1:4 to 4:1, from 1:3 to 3:1, or from 1:2 to 2:1 by weight of particles. In some preferred embodiments, the ratio may be in the range from about 1:5 to 10:1

The outermost coating layer may further comprise a binder and or other additives, materials, or components. For example, the binder may comprise one or more selected from polyvinyl alcohol (PVA), poly-N-vinylacetamide (PNVA), carboxymethyl cellulose (CMC), polyacrylic acid (PAA), polyvinyl acetate (PVAc), or combinations thereof.

In accordance with at least certain aspects, objects or embodiments, the inventive coating with PTFE particles is made with an aqueous coating slurry or formulation or an aqueous acrylic coating slurry having at least one binder, PTFE particles, and optional additional additives, materials, or components. Further, at least selected aspects, objects or embodiments include new or improved coatings with PTFE particles for porous or microporous membranes or substrates, including battery separators or separator membranes or base films, new and/or improved coated porous or microporous membranes or substrates, including battery separators, new or improved coatings for porous or microporous membranes or substrates, including battery separators, new or improved coatings, coating slurries, or coating formulations which comprise at least (i) a polymeric binder, (ii) PTFE particles, and (iii) at least one component selected from the group consisting of a cross-linker, a low-temperature shutdown agent, a diffusion agent, and a thickener, and/or new or improved coated porous or microporous polymer membranes or substrates where the coating comprises at least PTFE particles.

In some embodiments, the outermost coating layer may have a thickness from . 1 to 20 microns, from 1 to 19 microns, from 1 to 18 microns, from 1 to 17 microns, from 1 to 16 microns, from 1 to 15 microns, from 1 to 14 microns, from 1 to 13 microns, from 1 to 12 microns, from 1 to 11 microns, from 1 to 10 microns, from 1 to 9 microns, from 1 to 8 microns, from 1 to 7 microns, from 1 to 6 microns, from 1 to 5 microns, from 1 to 4 microns, from 1 to 3 microns, or from 1 to 2 microns.

In some embodiments, the outermost coating may have a coefficient of friction (COF) is less than 0.4, less than 0.35, less than 0.3, less than 0.25.

In some embodiments, the outermost coating may have a melting point above 300° C. or about 320° C..

In some embodiments, the outermost coating comprising PTFE particles may be added, for example, at about 1 to 20 grams per square meter (gsm) of separator, at 1 to 15 gsm, or possibly preferably at 1 to 10 gsm.

In some embodiments, the JIS Gurley(s) of the coated separator is about 1 s to about 300 s, 1 s to 200 s, 1 s to about 100 s, 1 s to about 50 s, or 1 s to about 30 s higher than that of the battery separator itself, i.e., without the coating or any coating. This is when the added coating is from 0.1 to 4 microns thick. Thicker coatings will typically result in higher Gurley increase.

Described herein are coated battery separators adapted or suited for use in secondary batteries such as but not limited to secondary lithium ion batteries. The coating is provided on one or both sides of the battery separator. The coating comprises polytetrafluoroethylene (PTFE) particles and the coating is an outermost coating layer. In some cases, the coating may also comprise ceramic particles.

### EXAMPLES

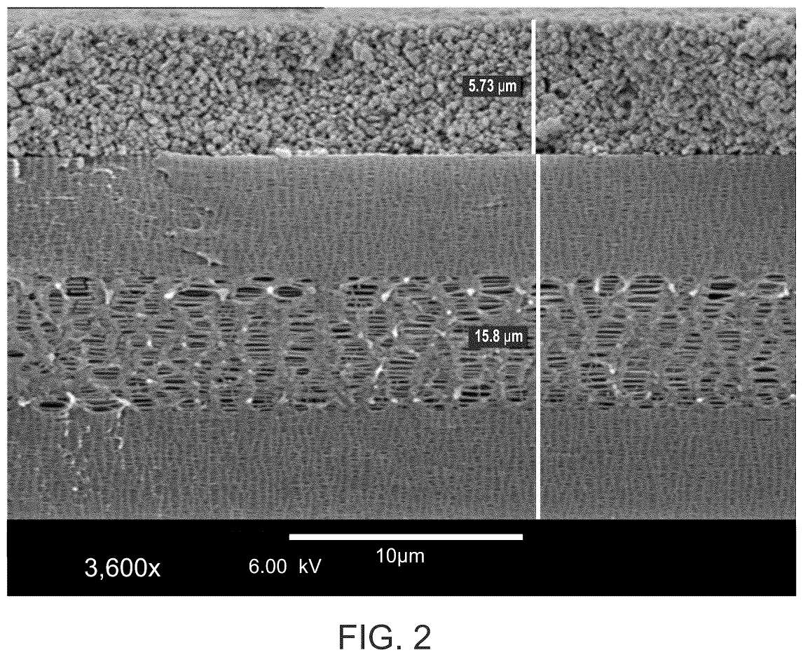

One Comparative Example and six Inventive Examples were prepared and tested. FIG. 1 and FIG. 2 shows an SEM of a coated trilayer film according to some embodiments described herein. In all examples, the trilayer base film has a Gurley of 178 seconds. More description of the Examples is as follows:

Comparative Example 1: An about 5-micron film was provided on a trilayer polyolefin battery separator having a thickness of about 16 microns. The film contained only Al₂O₃ particles, and no PTFE particles.

Inventive Example 1: Example 1 is like Comparative Example 1, except the coating contained only PTFE particles, no ceramic particles (e.g., Al₂O₃)

Inventive Example 2: Example 2 is like Example 1 except that it has more binder than Inventive Example 1, resulting in a slightly higher coefficient of friction (COF) as shown in the data.

Inventive Example 3 (c-1): Example 3 is like the other examples, except In Example 3, the coating contained PTFE particles and Al₂O₃ particles. The ratio of PTFE to Al₂O₃ is 0.26:1.

Inventive Example 4(c-2): Example 4 is like Example 3, except the ratio is 1.58:1.

Inventive Example 5(c-3): Example 5 is like Example 3, except the ratio is 3.95:1.

Inventive Example 6 (c-4): Example 6 is like Example 3, except the ratio is 9.47:1.

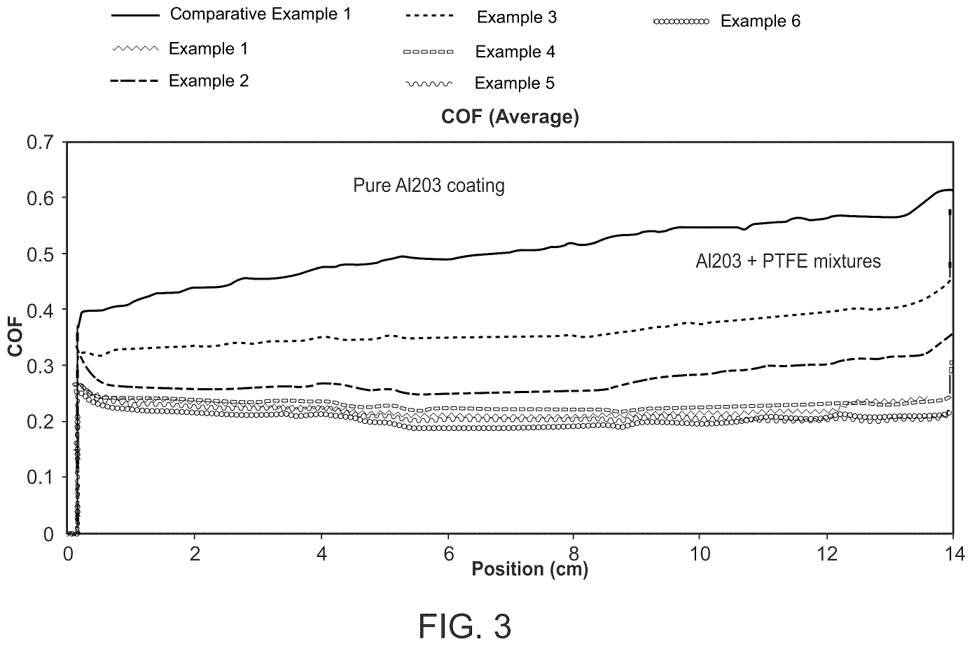

The coefficient of friction (COF) for the coating of each example was tested, and the results are reported in FIG. 3. A sample for COF testing was prepared and placed in an EZ Sled for COF testing, and it was ensured that the sample was tight with no wrinkles or slack. The ASTM D1894 (standard test method for static and kinetic coefficients of friction of plastic film and sheeting English in/gms) was then performed. Parameters for force of (N), distance of (cm), and sled of (200g) were used.

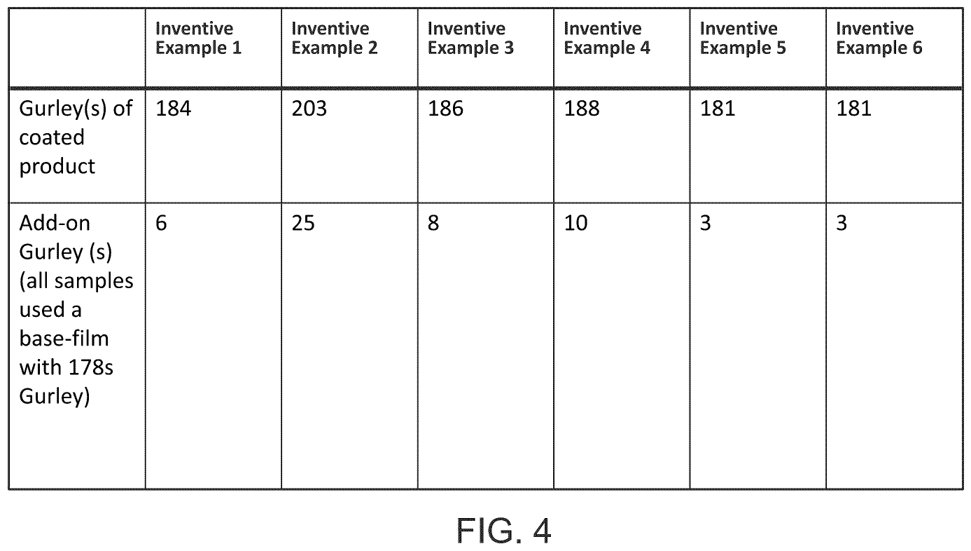

The Gurley increase caused by providing the coating to the battery separator (add-on Gurley) was also tested, and results are reported in FIG. 4. The data shows that coated separators have a lower coefficient of friction (COF) compared to comparative coated separators having only ceramic in the coating (e.g., Al₂O₃). This will alleviate an issue with ceramic coatings being deteriorative of battery making equipment. The coatings described herein also have low Gurley add-on, so that ion flow across the membrane is not so affected as with other types of coatings (e.g., PTFE coatings using an organic solvent based coating slurry, which result in coated products with high or even infinite Gurley). Add-on Gurley (JIS Gurley measured in seconds) is the difference in Gurley between the coated and un-coated battery separator. It tells us how much Gurley is “added-on” due to the addition of the coating to the battery separator.

1. A coated battery separator, comprising:
a battery separator; and
a coating layer on at least one side of the battery separator, wherein the coating comprises polytetrafluoroethylene (PTFE) particles and wherein the coating is an outermost coating layer.

2. The coated battery separator of claim 1, wherein the coating comprises 10% to 100% PTFE particles by weight of the particles.

3. The coated battery separator of claim 1, wherein the coating also comprises ceramic particles.

4. The coated battery separator of claim 1, wherein the ceramic particles are one or more selected from SiO₂, Al₂O₃, CaCO₃, TiO₂, SiS₂, SiPO₄, boehmite (y-AlO(OH)), and AlO(OH).

5. The coated battery separator of claim 3, wherein the coating is a ceramic coating.

6. The coated battery separator of claim 1, wherein the coating does not comprise fluoropolymers other than PTFE.

7. The coated battery separator of claim 1, wherein the coating consists essentially of PTFE particles and optionally a binder.

8. The coated battery separator of claim 7, wherein the binder is an acrylic binder.

9. The coated battery separator of claim 1, wherein the coating has a coefficient of friction (COF) less than 0.4.

10. The coated battery separator of claim 9, wherein the COF is less than 0.35.

11. The coated battery separator of claim 9, wherein the COF is less than 0.30.

12. The coated battery separator of claim 9, wherein the COF is less than 0.25.

13. The coated battery separator of claim 1, wherein the coating has a melting point above 300° C. or above 320° C..

14. The coated battery separator of claim 3, wherein the coating has a melting point above 300° C. or above 320° C..

15. The coated battery separator of claim 7, wherein the coating has a melting point above 300° C. or above 320° C..

16. The coated battery separator of claim 1, wherein the coating is formed using an aqueous coating slurry.

17. The coated battery separator of claim 1, wherein the battery separator is a shutdown separator, and the coating extends shutdown.

18. The coated battery separator of claim 1, wherein the battery separator is a polyolefin battery separator.

19. The coated battery separator of claim 1, wherein the battery separator comprises another coating that is the same as or different from the coating comprising PTFE particles.

20. The coated battery separator of claim 1, wherein the coated battery separator has a JIS Gurley(s) that is about 1 s to about 300 s greater than the JIS Gurley(s) of the battery separator itself when a 0.1 to 4 micron coating is added.

21. The coated battery separator of claim 20, wherein the coated battery separator has a JIS Gurley(s) that is less than 50 s greater than the JIS Gurley(s) of the battery separator itself when a 0.1 to 4 micron coating is added.

22. The coated battery separator of claim 1, wherein the coating comprises 10% PTFE particles by weight of particles.

23. The coated battery separator of claim 1, wherein the coating comprises 100% PTFE particles.

24. The coated battery separator of claim 1, wherein the coating layer has a moisture content of 300-400 ppm or less.

25. A lithium ion battery comprising the coated battery separator of claim 1.

26. A coated polyolefin membrane, comprising:
a polyolefin membrane; and
a coating layer on at least one side of the polyolefin membrane, wherein the coating comprises polytetrafluoroethylene (PTFE) particles and wherein the coating is an outermost coating layer.

27. The coated battery separator of claim 1, wherein the outermost coating comprising PTFE particles may be added, for example, at about 1 to 20 grams per square meter (gsm) of separator, at 1 to 15 gsm, or possibly preferably at 1 to 10 gsm.

28. The coated polyolefin membrane of claim 26, wherein the outermost coating comprising PTFE particles may be added, for example, at about 1 to 20 grams per square meter (gsm) of separator, at 1 to 15 gsm, or possibly preferably at 1 to 10 gsm.

29. The coated battery separator of claim 3, wherein the coating has a coefficient of friction (COF) less than 0.4.
